(19) United States
(12) Patent Application Publication
(10) Pub. No.: US 2026/0268453 A1
(43) Pub. Date: Sep. 10, 2026

(54) Digital Image Restoration Using Diffusion Models

(71) Applicant: Google LLC, Mountain View, CA (US)

(72) Inventors: Mauricio Delbracio, Sunnyvale, CA (US); Peyman Milanfar, Menlo Park, CA (US)

(21) Appl. No.: 19/167,692

(22) PCT Filed: Mar. 20, 2024
(86) PCT No.: PCT/US2024/020658

§ 371 Date: Sep. 22, 2025

Related U.S. Application Data
(60) Provisional application No. 63/491,176, filed on Mar. 20, 2023.

(51) Int. Cl. G06T 5/60; G06T 5/50

(52) U.S. Cl. CPC G06T 5/60; G06T 5/50; G06T 2207/20081; G06T 2207/20221

(57) ABSTRACT

Provided is an iterative image restoration process using low-quality images paired with the desired high-quality restored image as training data for the one or more image restoration models.

### CROSS-REFERENCE TO RELATED APPLICATIONS

The present application claims priority to U.S. Provisional Patent Application No. 63/491,176, filed Mar. 20, 2023, the entire disclosure of which is hereby incorporated by reference in its entirety.

### FIELD

The present disclosure is directed to digital image restoration. In particular, the present disclosure is directed to an iterative image restoration process using low-quality images paired with the desired high-quality restored image as training data for the one or more image restoration models.

### BACKGROUND

Recovering a high-quality image from a low-quality image is a fundamental problem in computer vision and computational imaging. Single image restoration is a highly ill-posed inverse problem where multiple plausible sharp and clean images could lead to the same blurry and noisy observation. Typical approaches, which utilize supervised learning, formulate image restoration as a problem of inferring an underlying image given a low-quality version of the underlying image by training a model using paired examples of relevant degradation. For example, if given a training pair including a high-quality image and a degraded (e.g., blurred, compressed, includes added noise etc.) representation of the high-quality image, existing approaches will attempt to predict the high-quality image using the degraded representation by minimizing expected pixel error.

However, these approaches result in a prediction that is a weighted average of all plausible reconstructions of the high-quality image, which can lack natural appearance, such as missing details. The more ill-posed the inverse problem is, the larger the set of plausible reconstructions is, and therefore the larger the effect on typical regression-to-the-mean used to train current restoration models, which leads to models that do not perform as well.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for performing digital image restoration. The method includes receiving a degraded image, wherein the degraded image is used as an initial image for a current image for processing. For each step in a specified number of steps, the method also includes inputting the current image into the image restoration model, receiving, from the image restoration model, a prediction of a final image based on the input current image, combining the current image, the prediction of the final image, and a noise sample into an output image; and setting a state of the current image to the output image, after the specified number of steps have been performed, the method further includes outputting the current image as a restored image.

Another example aspect of the present disclosure is directed to a computing system for performing digital image restoration. The computing system includes one or more processors and a non-transitory, computer readable medium comprising instructions that, when executed by the one or more processors, cause the one or more processors to perform operations. The operations include receiving a degraded image, wherein the degraded image is used as an initial image for a current image for processing. For each step in a specified number of steps, the operations also include inputting the current image into the image restoration model, receiving, from the image restoration model, a prediction of a final image based on the input current image, combining the current image, the prediction of the final image, and a noise sample into an output image, and setting a state of the current image to the output image. After the specified number of steps have been performed, the operations further include outputting the current image as a restored image.

Another example aspect of the present disclosure is directed to a computer-implemented method of training an image restoration model. The method includes receiving an image pair comprising a low-quality degraded image and a high-quality restored image and setting the degraded image as an initial image for a current image, for each step in a number of steps, the method also includes generated a prediction of the restored image based on the current image, combining the prediction of the restored image, the current image, and a noise sample to generate an output image, comparing the output image to the restored image and minimizing a loss function based on the comparison.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow chart illustrating operation of an image restoration model according to example embodiments of the present disclosure.

FIG. 2 depicts a flow chart illustrating a method of training of an image restoration model according to example embodiments of the present disclosure.

FIG. 3A depicts a block diagram of an example computing system that performs image restoration according to example embodiments of the present disclosure.

FIG. 3B depicts a block diagram of an example computing device that performs image restoration according to example embodiments of the present disclosure.

FIG. 3C depicts a block diagram of an example computing device that performs image restoration according to example embodiments of the present disclosure.

Reference numerals that are repeated across plural figures are intended to identify the same features in various implementations.

### DETAILED DESCRIPTION

### Overview

Generally, the present disclosure is directed to digital image restoration. In particular, one example aspect of the present disclosure is directed to an iterative image restoration process using low-quality images paired with the desired high-quality restored image as training data for the one or more image restoration models.

These models can include a denoising diffusion model that is trained in a supervised manner using paired examples (e.g., a low-quality image to be restored and the resulting desired high-quality image) that is conditioned on the low-quality image of the paired example. The denoising network can learn to generate the high-quality image based on the low-quality image.

After training, the model can be configured to generate a restored image by receiving the low-quality, degraded image and processing the degraded image to create a predicted final image. The predicted final image can be combined with the degraded image and a noise sample to create an output image. The output image can then replace the original degraded image as the current image for processing. This process can be repeated for a number of steps, with each iteration of the process resulting in a higher-quality output image. After the final step, the resulting output image can be the final, high-quality restored image.

More particularly, single image restoration is a highly ill-posed inverse problem where multiple plausible sharp and clean images could lead to blurry and noisy observation. Example implementations of the proposed approach explicitly addresses the ill-posed issue by an iterative restoration scheme where, at each step, an inverse problem is solved that is easier (less ill-posed) than the original.

Therefore, a sequence of intermediate restoration problems are solved, where at each step the goal is to reconstruct a slightly less corrupted image. This sequence of intermediate restoration problems takes the low-quality input to a high-quality reconstruction through a series of slightly less corrupted signals. This is accomplished using a single deep model that is trained to predict a clean image given an image with an intermediate degradation.

Therefore, an analytic form of the degradation process is not required and an iterative restoration process can be learned from low-quality/high-quality paired examples. Higher-quality restored images can be created using this iterative process than state-of-the-art regression formulations while maintaining high fidelity with respect to the original sample.

With reference now to the Figures, example embodiments of the present disclosure will be discussed in further detail.

### Example Model Arrangements

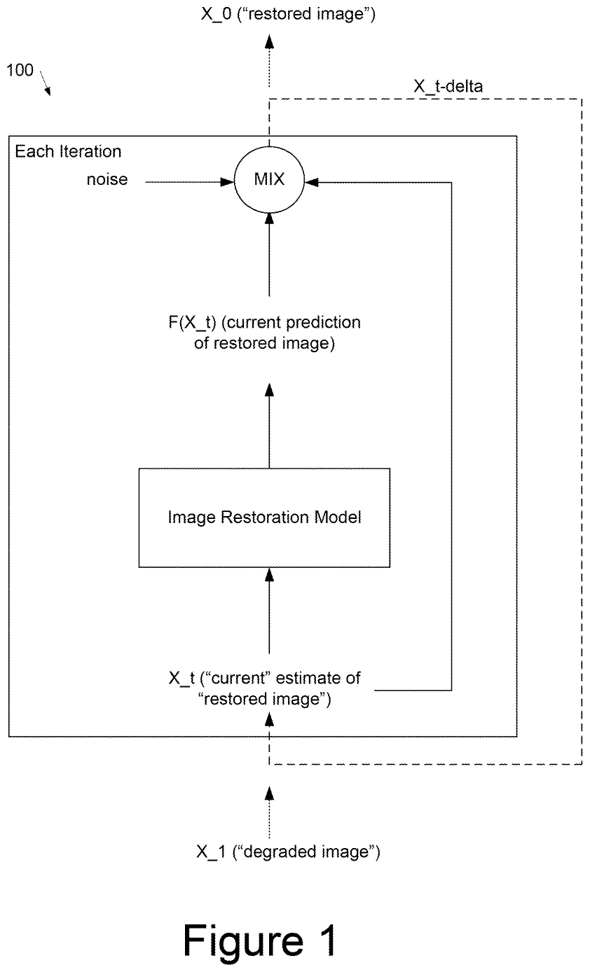

FIG. 1 depicts a flow chart illustrating operation of an image restoration model 100 according to example embodiments of the present disclosure.

The image restoration model 100 is generally configured to receive a low-quality image (e.g., an image that includes large amounts of noise, such as blur, pixelation, and the like) and “restore” the received image to a high-quality output image by iteratively performing image restoration on a series of generated images. The series of generated images begins with the degraded image set as a current image for processing, which the image restoration model uses to predict a current version of the high-quality, fully restored image. This current version of the restored image is then combined with the degraded image and Gaussian noise to create a new iteration of the degraded image that is improved (of better quality) over the degraded image. The state of the current image for processing is set to this current version of the restored image and the process is then repeated iteratively for a number of steps defined either manually or automatically, where each iteration results in a higher-quality output image (current version of the restored image) than the last iteration. After the number of steps are completed, the final output image is the high-quality restored image.

The image restoration model 100 can perform a forward degradation process defined by Equation 1.

$${x}_{t} = ( 1 - t ) x + ty , with t ∈ [ 0 , 1 ] \qquad Equation 1$$

In Equation 1, x is a high-quality image and y is a lower-quality degraded version of x. At time t=0, the forward degradation process can utilize the high-quality image x and degrade it by add blur, noise, and other modifications to the image to achieve the lower-quality degraded version y at time t=1. xₜ represents an intermediate degraded image between the high-quality image x that was originally input at time t=0 and the fully-degraded lower-quality version y at time=0. T can also be referred to a time step.

The image restoration model 100 can also implement a recovery method, which takes the lower-quality degraded version y as an initial input at time t=1 and, given time step t, generates a best possible reconstruction of the high-quality image x at time t−δ. To accomplish this generation of the best possible reconstruction at the given time step, a short-time conditional mean can be used, such as the short time conditional mean in Equation 2.

$${\hat{x}}_{t - δ} = 𝔼 [ {x}_{t - δ} \vert {\hat{x}}_{t} ] . \qquad Equation 2$$

By repeating this recovery process for a number of steps, defined manually or automatically, the full degradation performed by the forward degradation process described in Equation 1 can be inverted step-by-step.

A posterior mean at time s<t can be deduced from the best possible reconstruction at time t by first estimating the high-quality image x and then performing a convex combination with the estimate \hat{x}ₛ at time s. Equation 3 can then be applied to move from time t to s=t−δ.

$${\hat{x}}_{t - δ} = 𝔼 [ {x}_{t - δ} \vert {\hat{x}}_{t} ] = \frac{δ}{t} 𝔼 [ {x}_{0} \vert {\hat{x}}_{t} ] + ( 1 - \frac{δ}{t} ) {\hat{x}}_{t} \qquad Equation 3$$

This process can begin from \hat{x}₁=y, and the step δ<1 controls the “speed” of the recovery process (e.g., at constant “speed”,

$$δ = \frac{1}{N} ,$$

where N controls the total number of steps).

In some embodiments, for Equation 3 to be well defined, it can be required that [symbol] [x₀|\hat{x}ₜ] is well-defined. This can require that pₓ_{ₜ}(\hat{x}ₜ)>0. This requirement that pₓ_{ₜ}(\hat{x}ₜ)>0 be well-defined can help ensure that the iterative process moves through a path of plausible samples it at every step t. To guarantee this movement, a small amount of noise can be added to the lower-quality degraded image y, which ensures that p(y), and therefore p(xₜ) will be non-zero everywhere.

The ideal iterative scheme for performing recovery can include a requirement that, at each iterative step, an estimate of the complete high-quality image be computed. To accomplish this computation, one or more regressors can be utilized, where each regressor can be specialized in reconstructing the high-quality image x given the current intermediate degraded image xₜ at a given time, which can be modeled using Equation 4.

$${min}_{θ} {𝔼}_{x , y ∼ p ( x , y )} {𝔼}_{t ∼ p ( t )} {‖ {F}_{θ} ( {x}_{t} , t ) - x ‖}_{p} \qquad Equation 4$$

In Equation 4, p(t) can be a predefined distribution for t, such as a uniform distribution. The model F_{θ} can allow incremental reconstruction, where from time step t a slightly less corrupted signal can be predicted at time t−δ. Therefore, the iterative scheme can be modeled as shown in Equation 5.

$${\hat{x}}_{t - δ} = \frac{δ}{t} {F}_{θ} ( {\hat{x}}_{t} , t ) + ( 1 - \frac{δ}{t} ) {\hat{x}}_{t} \qquad Equation 5$$

In Equation 5, 0<δ≤1. δ can be a function of time, but in other implementations, a constant time step

$$δ = \frac{1}{N}$$

can be used, where N is the number of steps.

As δ→0, Equation 5 leads to an ordinary differential equation as set forth in Equation 6.

$$\frac{d {x}_{t}}{d t} = {lim}_{δ \to 0} \frac{{x}_{t} - {x}_{t - δ}}{δ} = \frac{{x}_{t} - {P}_{θ} ( {x}_{t} , t )}{t} \qquad Equation 6$$

In Equation 6, the ideal case can be that F_{θ}(xₜ,t)= [symbol] [x₀|xₜ]. The differential equation in Equation 6 can be seen as a “residual flow” because the right-hand side is a normalized residual of the inversion process at time t. The residual flow can be used to analyze a specific case where a prior image is Gaussian in nature and the restoration task is performing denoising.

Returning to Equation 2, to ensure that regularity requirements are met for the iterative procedure, a small amount of white noise can be added to the low-quality input, which can lead to an improvement in generated image quality in certain tasks, especially tasks that involve restoration from deterministic degradations. The model with this added noise can then be modeled as shown in Equation 7.

$${x}_{t} = ( 1 - t ) x + {ty}^{′} = ( 1 - t ) x + ty + t ε n ∈ with t ∈ [ 0 , 1 ] \qquad Equation 7$$

In Equation 7, y′=y+εn, where ε is a small constant, such as 0.01, and where image values are in [−1,1]), and n~ [symbol] (0,Id).

In some embodiments, the model can be more generally formulized as a general Brownian motion, where the noise at each step can be controlled, as shown in Equation 8.

$${x}_{t} = ( 1 - t ) x + t y + \sqrt{t} {ε}_{t} {η}_{t} with t ∈ [ 0 , 1 ] \qquad Equation 8$$

In Equation 8, εₜ can be a non-negative function, and ηₜ can be the standard Brownian motion having zero mean and covariance tI at index t.

Using Equation 8 as the model, the base training objective for the model becomes Equation 9.

$${min}_{θ} {𝔼}_{x , y ∼ p ( x , y )} {𝔼}_{t ∼ p ( t )} {𝔼}_{n ∼ 𝒩 ( 0 , Id )} {‖ {F}_{θ} ( ( 1 - t ) x + t y + t {ε}_{t} n ; t ) - x ‖}_{p} \qquad Equation 9$$

This base training objective results in a general inference procedure for the model shown in Equation 10.

$${\hat{x}}_{t - δ} = \frac{δ}{t} {F}_{θ} ( {\hat{x}}_{t} , t ) + ( 1 - \frac{δ}{t} ) {\hat{x}}_{t} + ( t - δ ) \sqrt{{ε}_{t - δ}^{2} - {ε}_{t}^{2}} ζ . \qquad Equation 10$$

The reconstruction process in Equation 10 can start from t=1. \hat{x}₁=y+εn and n~ [symbol] (0,Id). At each step, a new ζ~ [symbol] (0,Id) can be sampled and noise can added to the current state. The added Gaussian noise is such that the noise at time t has variance t²εₜ² as required by Equation 8. To be well defined, εₜ needs to be a non-negative non-increasing function of t. In the limit case where εₜ=ε, the simplified case given by Equation 7 is present, while if

$${ε}_{t} = \frac{ε}{\sqrt{t}}$$

the noise perturbation is a pure Brownian motion.

### Example Methods

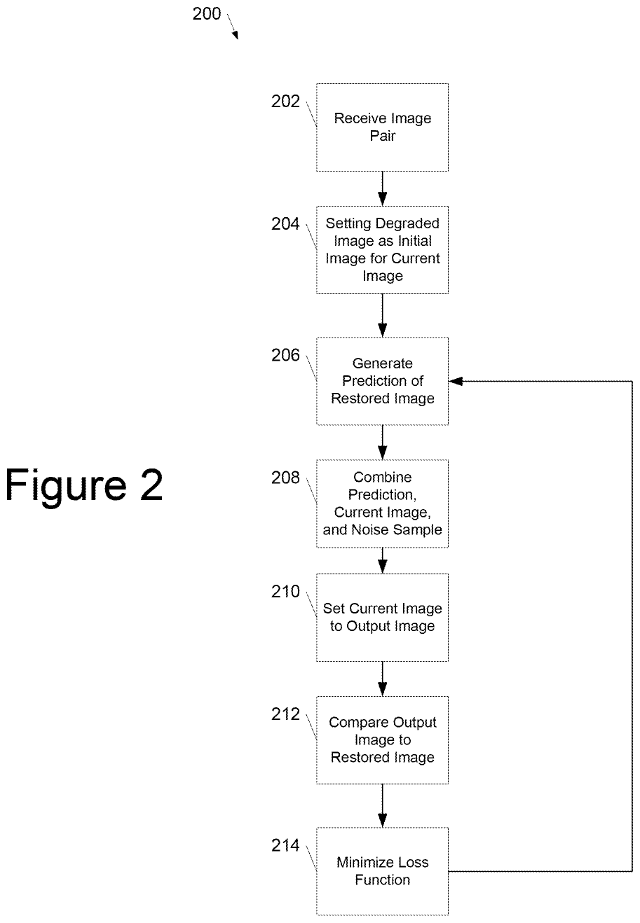

FIG. 2 depicts a flow chart diagram of an example method 200 to perform training of an image restoration model according to example embodiments of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At 202, a computing system receives an image pair as training data, the image pair including one low-quality, degraded image and a high-quality restored image. The low-quality, degraded image represents the same image as the high-quality, restored image but with one or more flaws in the image present, such as blur, pixelation, lack of focus, compression, and the like.

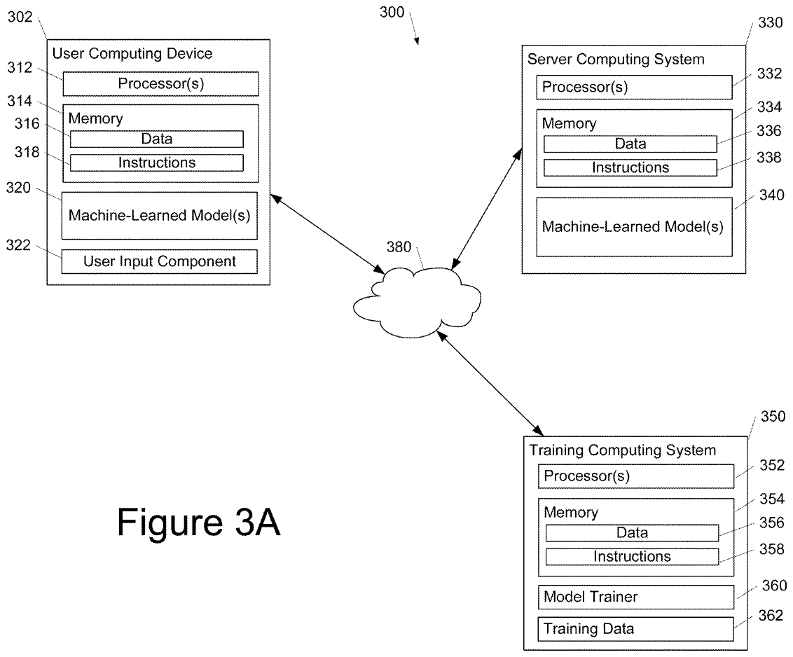

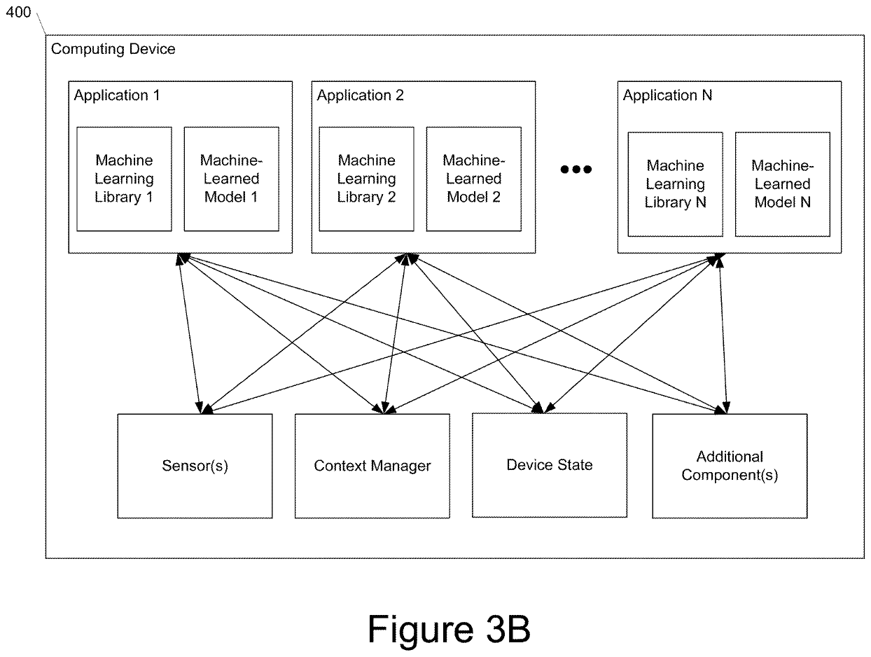

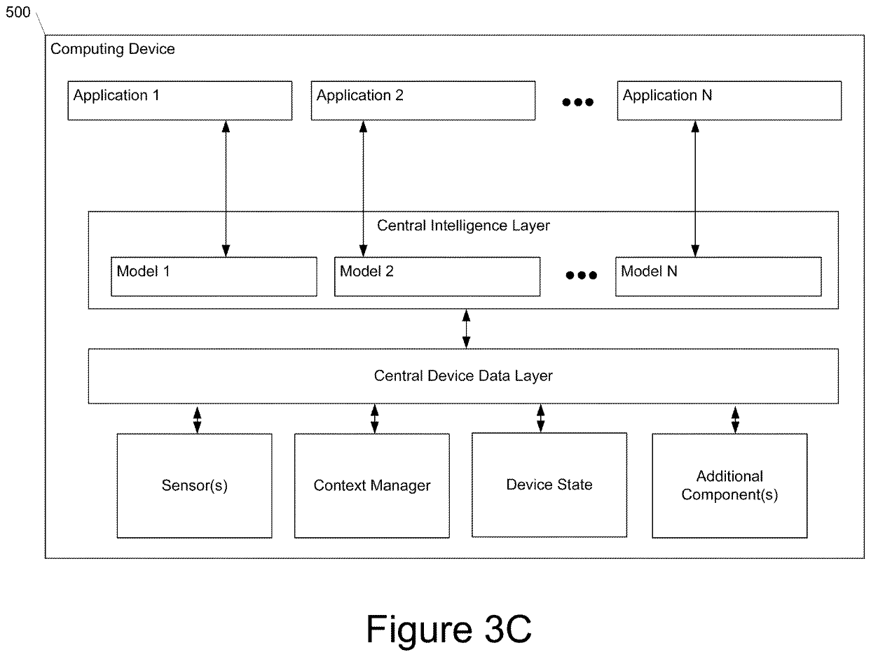

At 204, the computing system sets the degraded image as an initial image for a current image. The current image is the image currently being processed by an image restoration model, which is discussed above with regards to FIG. 1 and below with regards to FIG. 3A. The degraded image is therefore set as the first iteration or initial state of the current image to be processed by the image restoration model.

At 206, the computing system generates a prediction of the restored image based on the current image. The image restoration model takes the current image and predicts the final state of the restored image using, for example, a diffusion model.

At 208, the computing system combines the prediction of the restored image from 206, the current iteration of the image, and a noise sample to generate an output image. This output image represents an intermediate stage between the degraded image and the final, restored image.

At 210, the computing system sets the state of the current image to the output image in order to prepare for a new iteration of execution of the model with the newly generated image as the current image to be processed by the model.

At 212, the computing system compares the output image to the restored image to determine differences between the output image and the restored image.

At 214, the computing system minimizes a loss function based on the comparison. The loss function applies to the image restoration model and is minimized in order to train the model to accurately produce the restored image based on the originally input degraded image.

After the loss function is minimized, method 200 returns to step 206, where the current image is then processed again by the image restoration model and undergoes the same steps 208, 210, 212, and 214. This process is repeated for a number of steps either manually set by a user or until the output image matches the restored image to within a threshold value.

Method 200 can be repeated for a number of image pairs as training data so that the image restoration model can learn various flaws in images and properly restore those flaws.

### Example Devices and Systems

FIG. 3A depicts a block diagram of an example computing system 300 that performs image restoration according to example embodiments of the present disclosure. The system 300 includes a user computing device 302, a server computing system 330, and a training computing system 350 that are communicatively coupled over a network 380.

The user computing device 302 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 302 includes one or more processors 312 and a memory 314. The one or more processors 312 can be any suitable processing device (e.g., a processor core, a microprocessor, an ASIC, an FPGA, a controller, a microcontroller, etc.) and can be one processor or a plurality of processors that are operatively connected. The memory 314 can include one or more non-transitory computer-readable storage media, such as RAM, ROM, EEPROM, EPROM, flash memory devices, magnetic disks, etc., and combinations thereof. The memory 314 can store data 316 and instructions 318 which are executed by the processor 312 to cause the user computing device 302 to perform operations.

In some implementations, the user computing device 302 can store or include one or more image restoration models 320. For example, the image restoration models 320 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example image restoration models 320 are discussed with reference to FIG. 1.

In some implementations, the one or more machine-learned models 320 can be received from the server computing system 330 over network 380, stored in the user computing device memory 314, and then used or otherwise implemented by the one or more processors 312. In some implementations, the user computing device 302 can implement multiple parallel instances of a single image restoration model 320 (e.g., to perform parallel image restoration across multiple instances of image restoration).

More particularly, image restoration model is generally configured to receive a low-quality image (e.g., an image that includes large amounts of noise, such as blur, pixelation, and the like) and “restore” the received image to a high-quality output image by iteratively performing image restoration on a series of generated images. The series of generated images begins with the degraded image set as a current image for processing, which the image restoration model uses to predict a current version of the high-quality, fully restored image. This current version of the restored image is then combined with the degraded image and Gaussian noise to create a new iteration of the degraded image that is improved (of better quality) over the degraded image. The state of the current image for processing is set to this current version of the restored image and the process is then repeated iteratively for a number of steps defined either manually or automatically, where each iteration results in a higher-quality output image (current version of the restored image) than the last iteration. After the number of steps are completed, the final output image is the high-quality restored image.

Additionally or alternatively, one or more image restoration models 340 can be included in or otherwise stored and implemented by the server computing system 330 that communicates with the user computing device 302 according to a client-server relationship. For example, the image restoration models 340 can be implemented by the server computing system 340 as a portion of a web service (e.g., an image restoration service). Thus, one or more models 320 can be stored and implemented at the user computing device 302 and/or one or more models 340 can be stored and implemented at the server computing system 330.

The user computing device 302 can also include one or more user input components 322 that receives user input. For example, the user input component 322 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 330 includes one or more processors 332 and a memory 334. The one or more processors 332 can be any suitable processing device (e.g., a processor core, a microprocessor, an ASIC, an FPGA, a controller, a microcontroller, etc.) and can be one processor or a plurality of processors that are operatively connected. The memory 334 can include one or more non-transitory computer-readable storage media, such as RAM, ROM, EEPROM, EPROM, flash memory devices, magnetic disks, etc., and combinations thereof. The memory 334 can store data 336 and instructions 338 which are executed by the processor 332 to cause the server computing system 330 to perform operations.

In some implementations, the server computing system 330 includes or is otherwise implemented by one or more server computing devices. In instances in which the server computing system 330 includes plural server computing devices, such server computing devices can operate according to sequential computing architectures, parallel computing architectures, or some combination thereof.

As described above, the server computing system 330 can store or otherwise include one or more image restoration models 340. For example, the models 340 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 340 are discussed with reference to FIG. 1.

The user computing device 302 and/or the server computing system 330 can train the models 320 and/or 340 via interaction with the training computing system 350 that is communicatively coupled over the network 380. The training computing system 350 can be separate from the server computing system 330 or can be a portion of the server computing system 330.

The training computing system 350 includes one or more processors 352 and a memory 354. The one or more processors 352 can be any suitable processing device (e.g., a processor core, a microprocessor, an ASIC, an FPGA, a controller, a microcontroller, etc.) and can be one processor or a plurality of processors that are operatively connected. The memory 354 can include one or more non-transitory computer-readable storage media, such as RAM, ROM, EEPROM, EPROM, flash memory devices, magnetic disks, etc., and combinations thereof. The memory 354 can store data 356 and instructions 358 which are executed by the processor 352 to cause the training computing system 350 to perform operations. In some implementations, the training computing system 350 includes or is otherwise implemented by one or more server computing devices.

The training computing system 350 can include a model trainer 360 that trains the machine-learned models 320 and/or 340 stored at the user computing device 302 and/or the server computing system 330 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 360 can perform a number of generalization techniques (e.g., weight decays, dropouts, etc.) to improve the generalization capability of the models being trained.

In particular, the model trainer 360 can train the image restoration models 320 and/or 340 based on a set of training data 362. The training data 362 can include, for example, image pairs that include a low-quality, degraded image and an associated high-quality, restored image that represent the same image at different levels of image quality.

In some implementations, if the user has provided consent, the training examples can be provided by the user computing device 302. Thus, in such implementations, the model 320 provided to the user computing device 302 can be trained by the training computing system 350 on user-specific data received from the user computing device 302. In some instances, this process can be referred to as personalizing the model.

The model trainer 360 includes computer logic utilized to provide desired functionality. The model trainer 360 can be implemented in hardware, firmware, and/or software controlling a general purpose processor. For example, in some implementations, the model trainer 360 includes program files stored on a storage device, loaded into a memory and executed by one or more processors. In other implementations, the model trainer 360 includes one or more sets of computer-executable instructions that are stored in a tangible computer-readable storage medium such as RAM, hard disk, or optical or magnetic media.

The network 380 can be any type of communications network, such as a local area network (e.g., intranet), wide area network (e.g., Internet), or some combination thereof and can include any number of wired or wireless links. In general, communication over the network 380 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

FIG. 3A illustrates one example computing system that can be used to implement the present disclosure. Other computing systems can be used as well. For example, in some implementations, the user computing device 302 can include the model trainer 360 and the training dataset 362. In such implementations, the models 320 can be both trained and used locally at the user computing device 302. In some of such implementations, the user computing device 302 can implement the model trainer 360 to personalize the models 320 based on user-specific data.

FIG. 3B depicts a block diagram of an example computing device 400 that performs according to example embodiments of the present disclosure. The computing device 400 can be a user computing device or a server computing device.

The computing device 400 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 500 that performs according to example embodiments of the present disclosure. The computing device 500 can be a user computing device or a server computing device.

The computing device 500 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 500.

The central intelligence layer can communicate with a central device data layer. The central device data layer can be a centralized repository of data for the computing device 500. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for performing digital image restoration the method comprising:
receiving a degraded image, wherein the degraded image is used as an initial image for a current image for processing;
for each step in a specified number of steps:
inputting the current image into the image restoration model;
receiving, from the image restoration model, a prediction of a final image based on the input current image;
combining the current image, the prediction of the final image, and a noise sample into an output image; and
setting a state of the current image to the output image; and
after the specified number of steps have been performed, outputting the current image as a restored image.

2. The computer-implemented method of claim 1, wherein the image restoration model has been trained using supervised learning with training data comprising one or more paired images, each of the one or more paired images including a low-quality image and a desired high-quality restored image.

3. The computer-implemented method of claim 1, wherein the image restoration model is a diffusion model.

4. The computer-implemented method of claim 1, wherein the prediction of the final image is a best possible reconstruction of the restored image at the given step.

5. The computer-implemented method of claim 1, wherein the noise sample is a Gaussian noise sample.

6. The computer-implemented method of claim 1, wherein the noise sample is a general Brownian motion.

7. The computer-implemented method of claim 1, wherein the image restoration model is trained using image crop sizes of 128×128 pixels or 256×256 pixels.

8. A computing system for performing digital image restoration, the computing system comprising:
one or more processors; and
a non-transitory, computer readable medium comprising instructions that, when executed by the one or more processors, cause the one or more processors to perform operations, the operations comprising:
receiving a degraded image, wherein the degraded image is used as an initial image for a current image for processing;
for each step in a specified number of steps:
inputting the current image into the image restoration model;
receiving, from the image restoration model, a prediction of a final image based on the input current image;
combining the current image, the prediction of the final image, and a noise sample into an output image; and
setting a state of the current image to the output image; and
after the specified number of steps have been performed, outputting the current image as a restored image.

9. The computing system of claim 8, wherein the image restoration model has been trained using supervised learning with training data comprising one or more paired images, each of the one or more paired images including a low-quality image and a desired high-quality restored image.

10. The computing system of claim 8, wherein the image restoration model is a diffusion model.

11. The computing system of claim 8, wherein the prediction of the final image is a best possible reconstruction of the restored image at the given step.

12. The computing system of claim 8, wherein the noise sample is a Gaussian noise sample.

13. The computing system of claim 8, wherein the noise sample is a general Brownian motion.

14. The computing system of claim 8, wherein the image restoration model is trained using image crop sizes of 128×128 pixels or 256×256 pixels.

15. A computer-implemented method of training an image restoration model, the method comprising:
receiving an image pair comprising a low-quality degraded image and a high-quality restored image;
setting the degraded image as an initial image for a current image;
for each step in a number of steps:
generating a prediction of the restored image based on the current image;
combining the prediction of the restored image, the current image, and a noise sample to generate an output image;
setting the current image to the output image;
comparing the output image to the restored image; and
minimizing a loss function based on the comparison.

16. The computer-implemented method of claim 15, wherein the image restoration model is a diffusion model.

17. The computer-implemented method of claim 15, wherein the prediction of the final image is a best possible reconstruction of the restored image at the given step.

18. The computer-implemented method of claim 15, wherein the noise sample is a Gaussian noise sample.

19. The computer-implemented method of claim 15, wherein the noise sample is a general Brownian motion.

20. The computer-implemented method of claim 15, wherein the image restoration model is trained using image crop sizes of 128×128 pixels or 256×256 pixels.
